(19) United States
(12) Patent Application Publication
(10) Pub. No.: US 2021/0190974 A1
(43) Pub. Date: Jun. 24, 2021

(54) SYSTEMS AND METHODS FOR TRACKING AND CERTIFICATION OF MATERIALS USING RADIOISOTOPES

(71) Applicant: Scientific Certification Systems, Inc., Emeryville, CA (US)

(72) Inventors: Tobias Schultz, Concord, CA (US); Sofia Andrighetti, Fremont, CA (US)

(73) Assignee: Scientific Certification Systems, Inc., Emeryville, CA (US)

(21) Appl. No.: 17/123,158

(22) Filed: Dec. 16, 2020

Related U.S. Application Data
(60) Provisional application No. 62/950,185, filed on Dec. 19, 2019.

(51) Int. Cl. G01T 1/167

(52) U.S. Cl. CPC G01T 1/167

(57) ABSTRACT

A method for tracing materials to its source through the insertion of one or more physical tracers made of one or more radioisotopes at the source or sources, and the measurement of radioactivity at the source(s), as well as latter stages of the product production process are disclosed. The radioactivity data at the insertion time, as well as at every stage in which it is measured, is securely stored in one or more databases. The material to source matching process is accomplished by reading each radioisotope's radioactivity and comparing it to the emissivity it would have if coming from a determined source which is predictable.

### PRIORITY CLAIM AND CROSS-REFERENCE

This application claims the benefit of U.S. Provisional Application No. 62/950,185, filed Dec. 19, 2019, which application is expressly incorporated by reference herein in its entirety.

### BACKGROUND OF THE INVENTION

In some applications, it may be necessary or desirable to track materials such that the source of the material and/or the processing steps that the material undergoes can be determined. For example, it may be desirable to determine whether materials used in a product are so called “conflict materials,” or materials that may be aiding to finance conflict in areas such as the Democratic Republic of Congo. Tracking the source of such materials may allow manufacturers to ensure that they are not contributing to such conflicts.

U.S. Pat. No. 8,864,038 discloses systems and methods for encoding information in a material using a material tracing system. The tracing methods include storing information to be encoded in the material, generating a number based on the information, determining an amount of at least one tracer to be incorporated into the material corresponding to the number, and incorporating the determined amount of the at least one tracer into the material. Decoding information encoded in the material includes measuring an amount of the at least one tracer, in some embodiments after tracer insertion, determining a number corresponding to the measured at least one tracer, and decoding the number to obtain information associated with the material. The tracer can include one or more radioactive elements or radioisotopes.

Radioisotopes are radioactive forms of elements. Many types are used for various purposes in industry. Radioactive decays cause the isotope to transmute into another isotope (or element). The half-life of the isotope characterizes the time it takes for half of the mass of the isotope to be transmuted. Radioisotopes decay through “pathways” composed of (usually multiple) discrete steps. The types of decay (alpha, beta, gamma, neutron), and energy levels of each decay are significant in that they determine the types of equipment needed to detect radiation, the ability of the radiation to penetrate (and therefore exit, enabling detection) material in which they are present, and how much of a radioisotope can be present without presenting a health danger to nearby people. Certain types of radioactivity are more dangerous than others and, generally, higher energy levels of decay are also more dangerous. The most dangerous form of radioactivity are gamma rays, which can penetrate common materials.

The radioactivity of virtually all known radioisotopes is characterized in databases such as the International Atomic Energy Agency (IAEA) Evaluated Nuclear Structure Data File. The key radiation data is often expressed in decay diagrams that are used by nuclear scientists to summarize salient radioactive information of materials in a compact way.

### BRIEF DESCRIPTION OF THE DRAWINGS

FIG. 1 shows a schematic of a process for tracking the flow of material in a supply chain, according to one embodiment.

FIG. 2 shows a flowchart of a method of introducing radioisotope tracers into a batch of material, according to one embodiment.

FIG. 3 shows an exemplary diagram for verifying the provenance of a material, according to one embodiment.

FIG. 4 shows a flowchart of a method for determining the source of a material, according to one embodiment.

FIG. 5 shows a computing environment for tracking material, according to one embodiment.

### DETAILED DESCRIPTION OF THE INVENTION

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

The systems and methods described herein include adding radioactive material(s) to a batch of material and detecting the inherent radioactivity of the resulting material to track the batch of material throughout a supply chain. The radioactive material can be added to the batch of material at various stages of the supply chain, such as, for example, at the mining site, at a smelt operation, or before or after refining of the material. Detecting radiation resulting from the decay of the isotope can then be used to track the material throughout the remainder of the supply chain, since the resulting type, energy level, and amount, of radiation, will be specifically known and based solely on the amount of radioisotope initially inserted, the radioactive decay spectrum of the isotope, and its half-life. In various embodiments, a computer database is maintained of batches of material to which such radioactive materials have been added. By determining the amount of radioactive materials present in a material or component constructed of such a material (which is completed by measuring the amount of radiation of specific types and energy levels), the source batch of material can be identified in the database to verify the source of the material. Such a system can be used, for example, to maintain a database of materials that have been verified to originate from mines that are not in conflict zones.

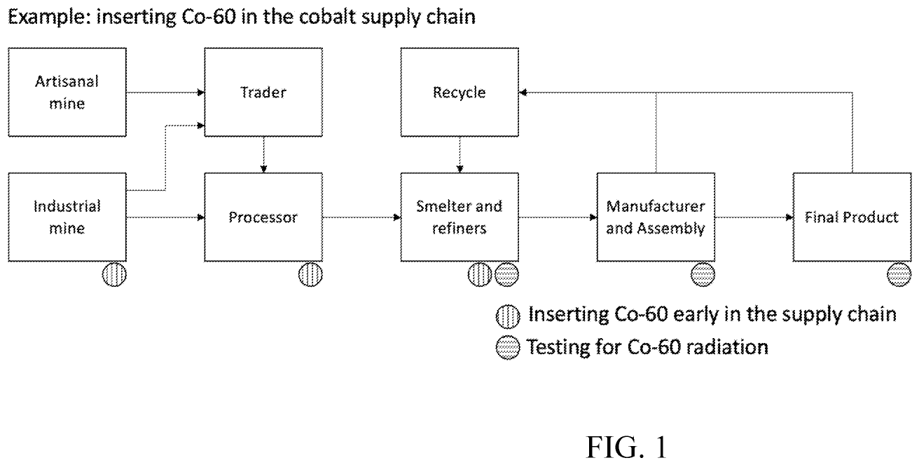

In one example, as shown in FIG. 1, a known amount of one or more radioisotope(s) is added to a batch of material at a mine, refinery, or other step in a supply chain. The radioisotopes can be, for example, Cobalt 60 and Zinc 65. Subsequently, a detector can be used to detect known decay particles of each radioactive tracer (e.g., for Cobalt 60, 1173 and 1332 keV gamma-rays, while for Zinc 65, 1115 keV gammas) in a material or component. Detection of the decay particles at subsequent steps of the supply chain can provide a participant in the supply chain, or an auditor, with confirmation that the material was processed at an approved refinery or was mined in an approved mine, for example, by confirming that the radioisotopes are present in specific ratios. For example, the auditor can query a database of materials, based on the amount of Cobalt-60 and Zinc 65 detected, to determine the source of the material.

In some embodiments, more than one radioisotope is added to the batch of material. In various embodiments, specific combinations and ratios of radioisotopes can be used to identify the source of a material. As used herein, “source” can mean the mine from which the batch of material is extracted, or any facility that performs one or more operations on the batch of material (e.g., smelting facility, refinery, etc.). The amounts of the radioisotope and the time and place of insertion can be maintained in a confidential database. Subsequently, the radioactivity of different isotopes are measured and compared to the database. This allows determination of the time and place of insertion of the radioisotopes and, therefore, the provenance of the metal.

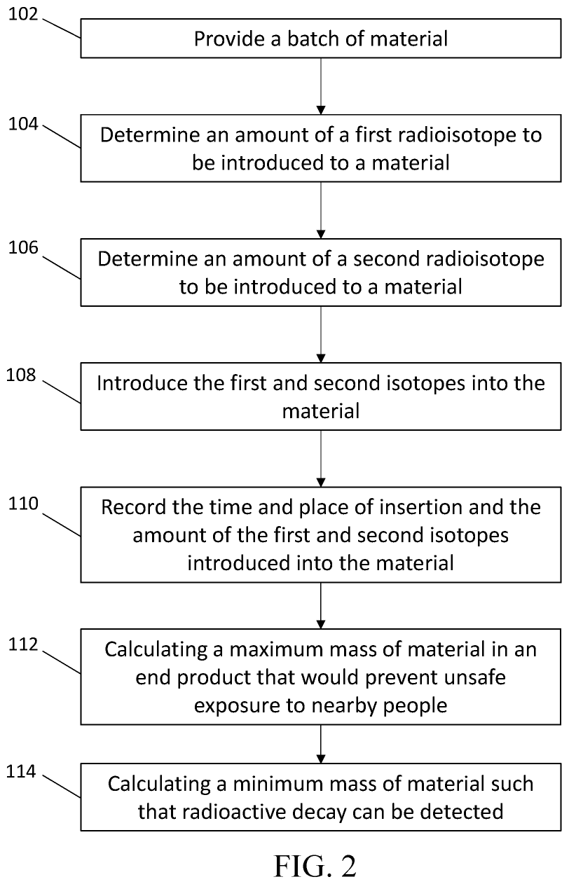

Referring to FIG. 2, at step 102, a batch of material can be provided (e.g., at a mine, refinery, etc.). At step 104, an amount of a first radioisotope to be introduced to the batch of material is determined. At step 106, an amount of a second radioisotope to be introduced to the batch of material is determined. The amount of radioisotopes to be added can be determined manually or by a computer, as described in further detail herein. The amount of radioisotopes are determined based on safety and detectability of the radiation emitted by the batch of material into which radioisotopes were inserted, as will be described further herein. At step 108, the first and second radioisotopes are introduced into the batch of material. For example, a known amount of Cobalt 60 and a known amount of Zinc 65 can be added as tracer elements into a batch of cobalt at a refinery. For example, 1 μCi of Cobalt-60 and 25 μCi of Zinc 65 may be added (i.e., a ratio of 25:1 ⁶⁵Zn:⁶⁰Co). Although the method is described in terms of adding two different radioisotopes to the batch of material, it should be understood that any number of different radioisotopes can be introduced to the batch of material. In some embodiments, increasing the number of different radioisotopes into the batch of material increases the difficulty of falsifying records.

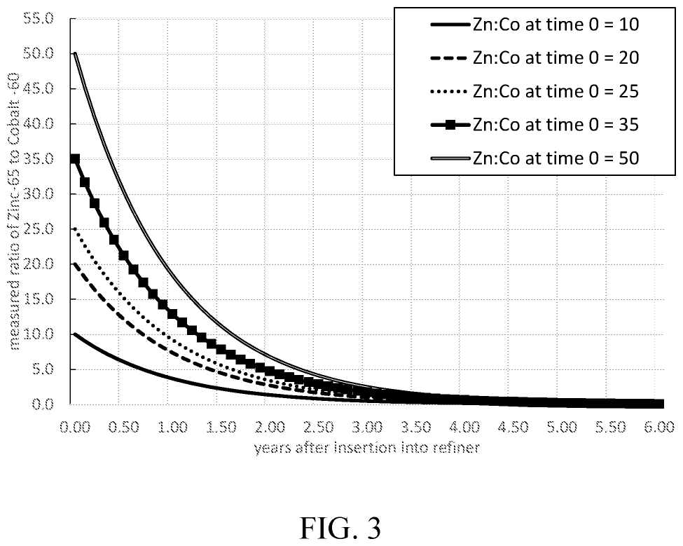

The method further includes, at step 110, recording the amount of each isotope added to the batch of material into a database and the time and place of introduction. The method can further include generating a curve providing the ratio of the radioisotopes in the batch at given times after addition of the radioisotopes to the batch of material. This curve can be used to verify the source of the material, as will be described in further detail herein. An exemplary set of curves is shown in FIG. 3.

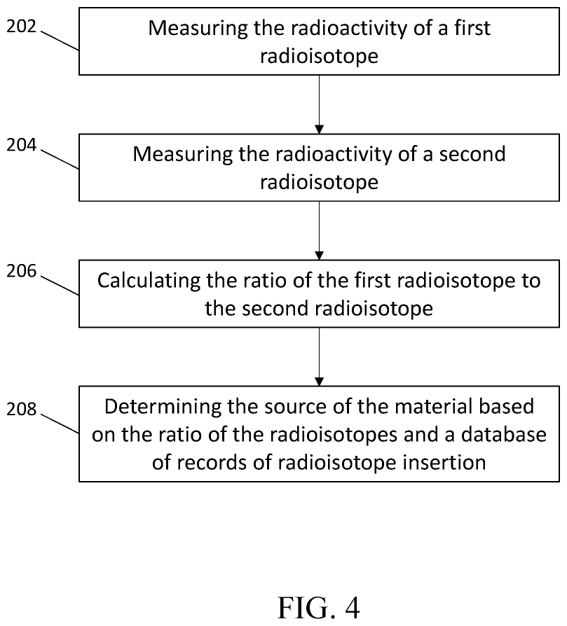

Turning to FIG. 4, at later steps in the supply chain, at step 202, the radioactivity of the first radioisotope is measured. For example, a first detector can be used to detect the 1173 or 1332 keV gamma-rays emitted during Cobalt 60 decay. At step 204 the radioactivity of the second radioisotope is measured. For example, another detector can be used to detect the 1115 keV decays from Zinc 65. It should be understood that the same or a different detector can be used to detect the gamma-rays from the Cobalt 60 and the Zinc 65. The resulting emissivity of each material is dictated by the amount of the radioisotope and its gamma ray spectrum. The emissivity is controlled by the amount of material remaining, which is dependent upon the half-life of each radioisotope, and can be calculated using the following equation:

$${R}_{i} = {R}_{i , 0} \times 0 . {5}^{\frac{- t}{{t}_{half}}}$$

where Rᵢ is the radioactivity, measured in counts or energy, R_{i,0} is the initial radioactivity of the radioisotope, t is the time after insertion of the radioisotope, and t_{half} is the half-life of the radioisotope.

At step 206, the ratio of the amount of first radioisotope in the material to the second radioisotope is calculated. If two radioisotopes are inserted into a batch of material at the same time, the ratio between the two is the equation below:

$$\frac{{R}_{1}}{{R}_{2}} = \frac{{R}_{1 , 0} \times {( 0.5 )}^{\frac{- t}{{t}_{1 , half}}}}{{R}_{2 , 0} \times {( 0.5 )}^{\frac{- t}{{t}_{2 , half}}}} = \frac{{R}_{1 , 0}}{{R}_{2 , 0}} \times {( 0.5 )}^{\frac{- t}{{t}_{1 , half}} - \frac{- t}{{t}_{2 , half}}} = \frac{{R}_{1 , 0}}{{R}_{2 , 0}} \times {( 0.5 )}^{t \times ( \frac{{t}_{1 , half} - {t}_{2 , half}}{{t}_{1 , half} \times {t}_{2 , half}} )}$$

where R₁ and R₂ are the radioactivity of each radioisotope (e.g., Cobalt 60 and Zinc 65), R_{1,0} and R_{2,0} are the initial radioactivity of the radioisotopes at the time of insertion, t is the time after insertion into the refiner, and t_{1,half} and t_{2,half} are the half-lives of each radioisotope.

After measuring the amount of radioactivity generated by each radioisotope and comparing such radioactivity, at step 208, a user then can refer to a database of records that includes information regarding the introduction of radioisotopes into the source material (e.g., by an upstream participant in the supply chain). Using the measured radioactivity levels and the database, the user can identify the source or provenance of the material based on the introduction of the radioisotopes by the upstream participant (e.g., at step 108) as well as the time of introduction of the radioisotopes. The identification of the source material can be determined based on a comparison of the radioactivity ratios calculated using the equations above with the ratio of the measured radioactivity levels of the sample. For example, radioisotopes can be added to materials at each refinery in a system of refineries, with the type and/or ratio of radioisotopes added at each refinery being different. Subsequent detection of radioactivity from different radioisotopes can be used to identify the refinery where the material was processed and even when it was processed.

Using the equation above, curves of the ⁶⁵Zn to ⁶⁰Co ratio of radioactivity over time are developed and can be used by auditors to identify the source of the material. The ratio of radioactivity depends only upon the initial ratio of ⁶⁵Zn to ⁶⁰Co, the half-life (which is invariant), gamma ray spectrum (which is also invariant), and the time since the insertion. This ratio is invariant to the size of the component and also does not change when the traced material is mixed with non-traced material.

In order to verify the material, an auditor, for example, can check for the presence of ⁶⁵Zn and ⁶⁰Co. The auditor can also confirm that the ⁶⁵Zn to ⁶⁰Co ratio correctly follows the curve. For example, using the example of the initial 25:1 ⁶⁵Zn:⁶⁰Co ratio, if the auditor were to measure the radiation levels of the cobalt anode in an electric vehicle battery, in which the cobalt supposedly came from a refiner making recycled cobalt, and the test was one year after the insertion of the zinc and cobalt, then the radiation tests must find that the ratio is ten, following the chart in FIG. 3. For example, if a test found a ⁶⁵Zn:⁶⁰ Co ratio of 20, and zinc and cobalt had only been introduced into two refiners, with one refiner introducing the radioisotopes at an initial ratio of ⁶⁵Zn:⁶⁰Co ratio 10, and the other at a ratio of 50, then it could be determined that the cobalt originated at the latter refiner, with a batch in which the tracers had been introduced one year ago. It should be understood that this determination could be made manually using a chart such as the one shown in FIG. 3. Alternatively, the amount of each radioactive material present in the component could be entered into a computing device and the computing device can query the database to determine the source material, as described further herein.

Any number of radioisotopes can be added to batches of material. For example, one, two, three, four, five, or more radioisotopes can be added to batches of material. In some embodiments, a group of radioisotopes are added to batches of material, while not all of such radioisotopes need be added to each batch of material. Increasing the number of radioisotopes used can increase the reliability of, and increase the confidence in, the analysis. In some embodiments, a kit of radioisotopes is provided to mine operators, refiners, etc. to introduce into designated batches of material.

The ratio of the radioactivity can also be used to determine the amount of material that has been mixed with radioisotope infused batches of material, since the ratio of the two radioisotopes is invariant even to the amount of material (e.g., cobalt) in which it is present. This can be done by calculating the mass concentration (parts-per-trillion) of individual radioisotopes from their inherent radioactivity—which is possible with standard equations. The amount of material which was mixed in can be calculated using the equation below:

$${T}_{new} = {T}_{total} - \frac{{M}_{i}}{{c}_{0 , i} \times {( 0.5 )}^{\frac{- t}{{t}_{i , half}}}}$$

where T_{new} is the amount of material mixed to the material of known provenance (grams), Tₜₒₜₐₗ is the measured total mass of material (grams), Mᵢ is the mass of radioisotope i (nanograms), calculated from its measured radioactive emissivity, c_{o,i} is the initial concentration at the time the radioisotope was inserted (nanograms per gram or parts-per-billion), t is the time after insertion (years); t_{i,half} is the half-life of the radioisotope (year).

As noted above, a variety of radioisotopes can be used in the systems and methods described herein. However, certain properties in the radioisotope are desirable. For example, in certain embodiments, the radioisotopes have a half-life over forty days. This ensures that approximately 10% of the radioisotope remains in the product after six months. This provides sufficient time for a material to be used in supply chains, where turnover in material can easily take this length of time. Further, the radioisotope emits gamma and/or beta radiation. This radiation may preferably be in the energy range of 20 keV to 3,000 keV, the range in which most radiation detectors operate.

Further, the radioisotope is selected such that it is not a neutron emitter. This prevents the material that the radioisotope is inserted into from becoming radioactive due to the emission of neutrons from the radioisotope.

In the case of materials that will be used for materials that are shielded in end use, the radioisotopes can be preferably selected such that they emit only beta radiation. In such applications, there will be no safety concerns as beta radiation will not penetrate the shielding, yet could be detected in unshielded components during manufacturing or by an auditor.

In some embodiments, the radioisotopes are selected to have the same proton number as the material in which it is mixed. Radioisotopes with the same proton number as the material in which they are mixed will have nearly identical chemistry, and so can persist even after chemical processing stages that the material undergoes. This means radioisotopes with the same proton number can be inserted into a material during mining and will still be detectable later in the supply chain (e.g., after refining).

Further, in some embodiments, the radioisotope is a material that is commonly used as an alloying agent or an additive after refining for the material desired to be traced. Materials that are commonly used in alloying materials are well-suited to insertion, as the chemistry is well understood and has desirable attributes in the final product. In other words, the effect on the structural and/or chemical properties of the material are known.

In embodiments in which more than one radioisotope is used, the radioisotopes can be selected such that the difference between the half-life of each radioisotope is at least 40 days. This ensures that a distinct difference in measured concentration over time is measured, allowing for a clear determination of the timing of when radioisotopes were inserted. If radioisotopes have very similar half-life values, their relative concentration will remain very similar, which may make it difficult to determine the time of insertion. Further, the distance between radiation peaks emitted by the selected radioisotopes can be at least 100 keV. Most radiation detectors have a resolution (full width at half maximum) of less than 100 keV. This means that detecting the different radioisotopes will be readily possible if at least 100 keV is maintained between at least one peak in each radiation spectrum.

In some embodiments, the radioisotopes are selected based on the timing of introduction to the material. For example, if the radioisotopes are introduced at the mining stage, radioisotopes with the same proton number may preferably be used. If introduced at the refining stage, commonly used alloys and/or additives are preferably used. Regardless of the stage, the radioisotope is preferably chemically stable within the material.

Further, in some embodiments, at step 112 and 114, maximum and minimum sizes of the end component can be determined to ensure safety to end users and detectability of the radioisotopes. At the point of insertion (e.g., at the mine, smelter, or refiner), little may be known about the end product that the material will be used for. For example, the specific size, geometry, and design of end products manufactured from the material may not be known (e.g., even if it is known that cobalt will be used in electric vehicle batteries, the specific amount of cobalt and how it is integrated into the battery may not be known). This may prevent the mine, smelter, or refiner, from precisely understanding what amount of radioisotope insertion may be both safe in end use but also detectable in the supply chain.

While the product the material will be used for is not known, the quantity of radioisotopes inserted into a material can be controlled. This, in turn, allows the radioactivity of a given amount of the material to be determined. Ratings for detectability and safety based on the amount of material (e.g., the mass or volume of material) can be set. Therefore, metals “tagged” with radioisotopes can be rated on a variety of parameters. For example, the minimum amount of product (e.g., in grams or pounds of the material) that can be detected in an unshielded component six months after insertion. In addition, the maximum amount (in grams or pounds) of the material that should be incorporated into an end user product to ensure that the radioactivity of the product is within the safety levels established by, for example, the International Atomic Energy Agency, this is 1 mSv for public exposure, (e.g., at a specified distance (e.g., 10 centimeters) and assuming no shielding) can be specified. For example, if 0.7 micro-Curies of Cobalt 60 is inserted into a 10-ton batch of refined, high purity cobalt, and 0.3 Bq is the minimum detectable amount using available equipment, then the minimum component size that could be authenticated for provenance (i.e., the size at which the radioactivity level is detectable) would be 100 grams of cobalt, and the maximum safe component size for use in EV batteries (assuming 10 centimeter distance) would be 1.2 tons of cobalt.

The smallest component in which the radioisotope could be detected can be calculated using the following equation:

$$C = RB \times \frac{D}{A} \times 0 . {5}^{\frac{- t}{{t}_{half}}}$$

where C is the minimum component size in which the radioisotope can be detected; RB is the size of the refinery “batch” into which the radioisotope was initially inserted; D is the minimum detectable amount of the radioisotope (estimated for Co-60 to be 3-6 picograms); A is the amount inserted into the refinery batch; t is the years after insertion into the batch; and Nair is the half-life of the radioisotope.

The maximum mass of material including a radioactive tracer that can be used unshielded (e.g., a component included in an end user product) may be able to be calculated using the following equation:

$${m}_{c} = \frac{{ED}_{SVtot} \times MM \times {D}_{tot}^{2}}{NA \times 4. 59 \times 1 {0}^{- 8} \times λ \times {c}_{R 0} \times 0 . {5}^{\frac{- t}{{t}_{half}}} \times {\sum }_{i = 0}^{spectrum} {f}_{i} \times Me {V}_{i} \times {μ}_{{L}_{i}}}$$

where ED_{SVtot} is the maximum safe effective dose, in Sieverts (e.g., 1 mSV for IAEA), c_{R0} is the concentration of the radioisotope at the time it is initially inserted into a material; m_{C} is the mass of the component; i is the i^{th} increment of the gamma ray spectrum; fᵢ is the fraction of radioactive decays which are in this increment; the energy level of the particles in this channel is MeVᵢ, in MeV; μ_{L}_{ᵢ} is the linear absorption coefficient in human tissue (using absorption in water as a proxy) for the energy level MeVᵢ, in units of cm⁻¹; t is the time (in years) since the radioisotope was initially inserted into the material; t_{half} is the half-life of the radioisotope; NA is the Avogadro's number; MM is the molar mass of the radioisotope; and Dₜₒₜ is the distance from the radiation source to the point of exposure.

Further, for example, using a distance of 10 centimeters and the 1 mSv/yr safe threshold (1.14×10⁻⁷ Sv per hour), and Avogadro's number (6.022×10²³) this equation can be simplified.

$${m}_{c} = \frac{4.13 \times {10}^{- 22} \times MM}{λ \times {c}_{R 0} \times 0 . {5}^{\frac{- t}{{t}_{half}}} \times {\sum }_{i = 0}^{spectrum} {f}_{i} \times Me {V}_{i} \times {μ}_{{L}_{i}}}$$

For a material in which Cobalt 60 has been introduced (λ=4.17×1.0⁻⁹ and a molar mass 59.933 g/mol), the equation can be written as follows:

$${m}_{c} = \frac{5.933}{{0.5}^{\frac{- t}{{t}_{half}}} \times {\sum }_{i = 0}^{spectrum} {f}_{i} \times Me {V}_{i} \times {μ}_{{L}_{i}}}$$

The radioisotopes can be introduced at any desired time in the supply chain. However, there are certain times in the supply chain that may provide particular benefits. Introducing the radioisotopes at the mine site may be preferred as it provides tracing of the chain of custody to the highest risk point in the supply chain. Metals after this stage are generally mixed before going to smelting, and the only tracing systems that currently exist are paper based tracking systems that are easily defrauded. Using the methods and systems described herein, a mine that is certified as conflict-free or responsible can insert a specific radioisotope mix to provide the ability for that material to be traced at later stages of the supply chain.

In some embodiments, the radioisotopes can be inserted after the mining ore has been concentrated. For example, the radioisotopes can be introduced when the metal is melted into a single block prior to sale. For example, it may be preferred to insert radioisotopes into gold when it is being melted into doré. If the mined product is instead an aggregate in the form of pellet or grains, the radioisotopes can still be inserted as pellets or granulates themselves, for example after the aggregate has gone through any purification or sorting which occurs at the mine site, but before it has left the mine site.

The end of the refining process, after all chemical impurities are removed and the highest desired metal purity are achieved, is another preferred time/place to introduce radioisotopes. Refiners are typically aggregation points for many mined and recycled sources, and so are an important control point in any chain-of-custody. Preferably, the radioisotopes are inserted while the metals are still molten, to ensure that the radioisotopes are mixed throughout the material. Many companies desire to source materials from refiners in certified programs (e.g., Responsible Minerals Initiative, LBMA). The introduction of radioisotopes by the refiner can be used to satisfy the requirements of these programs for determining metal provenance.

Further, smelters and refiners typically know the source of metals they purchase, since they may be purchasing directly from a mine. If radioisotope tracers have been introduced to the material at the mine, as described above, the refiner may be able to establish a chain-of-custody traced back to the mine. After determining the source of the material (either using radioactive tracers or other means), and mixing two or more such materials, the smelter or refiner can introduce additional radioisotopes for continued tracking of the material.

In embodiments in which the radioisotope has a proton number that is different than the material into which it is introduced, the tracer radioisotopes may be removed during refining. For this reason, introducing the radioisotope at the last stage of refining may be preferred so that tracking of the material at later points in the supply chain is possible. For example, in some embodiments, the radioactive tracers introduced at the mining stage are removed during refining and additional radioactive tracers are introduced after refining is complete.

Manufacturers often have a great deal of difficulty in identifying their smelters (or refiners) of origin. Insertion of radioisotopes by the smelter or refiner is advantageous, as the source of the material can be determined at later manufacturing stages.

A preferred time to insert radioisotopes into gold is at the very last stage of refining, while the gold is still molten. For refiners that have an integrated alloying facility (i.e., where the alloying is completed at the refinery stage), the radioisotopes can also be inserted during the alloying.

Table 1 summarizes combinations of the most desirable materials to inserted at the mine stage or after refining.

TABLE 1

| | Combination | |
|---|---|---|
| | of Isotopes | |
| | to be inserted | |
| Material | at the mine | Combination inserted at end of refining |
| Cobalt | Co⁵⁶, Co⁵⁷, | Mo⁹³, W¹⁸¹, W¹⁸⁵, W¹⁸⁸, Ni⁵⁹, Ni⁶³, Fe⁵⁵, Fe⁵⁹, |
| | Co⁵⁸, Co⁶⁰. | Fe⁶⁰, Co⁵⁶, Co⁵⁷, Co⁵⁸, Co⁶⁰ |
| Gold | Au¹⁹⁵ | Ag^{110m}, Ag¹⁰⁵, Zn⁶⁵, Pt¹⁹³, Ni⁶³, Au^{195,} A^{126,} |
| | | Cd^{109,} Cd^{109,} Cd^{115m,} Cd^{113m,} Cd¹¹³ |
| Platinum | Pt¹⁹³ | Ir¹⁹², Ir^{192m2}, Ir^{194m2} Co⁵⁶, Co⁵⁷, Co⁵⁸, Co⁶⁰, |
| | | Au¹⁹⁵, Ru¹⁰⁶, W¹⁸¹, W¹⁸⁵, W¹⁸⁸, Pt¹⁹³, Pd¹⁰⁷ |
| Tantalum | Ta¹⁷⁹, Ta¹⁸² | W¹⁸¹, W¹⁸⁵, W¹⁸⁸, Ta¹⁷⁹, Ta¹⁸², Nb^{93m}, Nb^{91m}, |
| | | Nb⁹⁴ |
| Tungsten | W¹⁸¹, W¹⁸⁵, | Fe⁵⁵, Fe⁵⁹, Fe⁶⁰, Ag^{110m}, Ag¹⁰⁵, W¹⁸¹, W¹⁸⁵, |
| | W¹⁸⁸ | W¹⁸⁸, C¹⁴ |
| Tin | Sn¹²³, Sn¹²⁶, | Sb¹²⁴, Sb¹²⁵, Pb²⁰⁵, Pb²¹⁰, Zn^{65,} Sn¹²³, Sn¹²⁶, |
| | Sn¹¹³, Sn^{119m}, | Sn¹¹³, Sn^{119m}, Sn^{121m} |
| | Sn^{121m} | |
| Iron | Fe⁵⁵, Fe⁵⁹ | Fe⁵⁵, Fe⁵⁹, C¹⁴ Al²⁶, Ti⁴⁴, Mn^{54,} W¹⁸¹, W¹⁸⁵, |
| | | W^{188,} Mo⁹³, Ni⁵⁹, Ni⁶³, Co⁵⁶, Co⁵⁷, Co⁵⁸, Co^{60,} |
| | | Sn¹²³, Sn¹²⁶, Sn¹¹³, Sn^{119m}, Sn^{121m} Zn^{65,} Zr^{88,} |
| | | Zr⁹⁵, Pb²¹⁰ |

The combinations of isotopes inserted at the mine are chosen because they have the same proton number as the material in which they would be seeded, and hence nearly identical chemistry. This means they will not be removed during refining. The combinations for insertion at the end of refining are commonly used alloying agents for the base material or have the same proton number as the base material.

The radioisotopes listed in Table 2 are pure beta emitters that may be preferred for insertion into metals used in electronics and battery manufacturing and in iron used in automotive steel. The use of beta emitting radioisotopes in such applications may be preferred because these components may be used in products in which the components are shielded. Because beta radiation will penetrate only a small distance in any type of material, their use ensures that there will be no safety concern for the end user even though the radioisotopes will be detectable. This means that higher amounts of the radioisotopes can be inserted, making them easier to detect in later supply chain stages. The radioisotopes listed in Table 2 may be desirable for these reasons.

TABLE 2

| | | |
|---|---|---|
| Ar-39 | Kr-85 | Sn-123 |
| Ar-42 | Ni-63 | Sr-89 |
| Be-10 | Pd-107 | Sr-90 |
| Bk-249 | Pm-147 | Tc-99 |
| C-14 | Pu-241 | Tm-171 |
| Ca-45 | Ru-106 | W-188 |
| Cd-113 | S-35 | Y-91 |
| Cd-113m | Se-79 | |
| Cs-135 | Si-32 | |
| In-115 | Sm-151 | |

The radioisotopes listed in Table 3 are pure beta emitters with maximum emission energies of less than 500 keV. These radioisotopes may be preferred for insertion into metals used in jewelry, electronics, battery manufacturing and in iron used in automotive steel. The penetration of beta radiation of these energies is very minor even though human skin, and their use ensures that there will be no safety concern for the end user even though the radioisotopes will be detectable. The radioisotopes listed in Table 3 may be desirable for these reasons.

TABLE 3

| | | |
|---|---|---|
| Bk-249 | Pd-107 | Si-32 |
| C-14 | Pm-147 | Sm-151 |
| Ca-45 | Pu-241 | Tc-99 |
| Cd-113 | Ru-106 | Tm-171 |
| Cs-135 | H-3 | W-188 |
| In-115 | S-35 | Re-187 |
| Ni-63 | Se-79 | |

There may also be preferred points in a supply chain for measuring the radioactivity in a material to determine its source. For example, it may be desirable to measure the radioactivity at stages where the materials are aggregated in an amount large enough to be detectable according to the minimum ratings determined based on the amount of radioactive material introduced to the source material. It may also be desirable to measure the radioactivity at stages where the material will not be sheathed or covered by any other components, or where it can readily be removed for testing so that the radiation is detectable.

It may also be preferred to measure radioactivity when a supply chain participant receives the material. This will authenticate the provenance of the material and establish an empirical link in its chain of custody before the participant takes steps to process the material. The testing can be performed at each stage of the supply chain until the radioactive elements are no longer detectable in sufficient quantities for identification. For subsequent stages in the supply chain, other forms of tracking can be used to establish a credible chain of custody.

Some specific examples of tracking and identifying material are now provided.

### Example 1: Cobalt Used in Anodes of Electric Vehicle Batteries

In the event of Cobalt used in anodes of electric vehicle (“EV”) batteries, the radioisotope tracers can be evaluated at the site the EV car is assembled. At this site, EV batteries can be disassembled and the radioactivity of their cobalt anodes measured to verify the source of the material. In some embodiments, a random sample of batteries can be chosen for measuring radioactivity levels (e.g., based on a quality assurance statistical sampling regime). Enough cobalt is used in EV batteries that the radiation signature should be detectable if unshielded. However, once cobalt anodes are incorporated into a battery assembly, they will be surrounded by relatively heavy metals like nickel that are quite effective at shielding radiation. Hence, to detect the radiation signature at the point of car manufacture, EV batteries would need to be disassembled and cobalt anodes directly subjected to a test.

In order to avoid disassembly of the battery, the radioisotope tracers can be evaluated prior to assembly of the EV battery. This allows the provenance of cobalt to be established prior to insertion of cobalt anodes into the battery assembly (i.e., before the anodes are completely shielded). Preferably, the evaluation of the radioisotopes can be performed when the cobalt is received by the EV battery manufacturer. This establishes a chain of custody prior to when cobalt is separated (and, potentially, processed) into anodes.

### Example 2: Gold and/or Platinum Used in Jewelry

For metals used in jewelry, the radioisotopes levels can be measured at the site where gold and/or platinum is manufactured into jewelry. At this stage, manufacturers purchase cast grains or wire, then melt them and cast into jewelry. The material (e.g., gold and/or platinum) can be tested (e.g., by the manufacturer) before melting the material down to make jewelry. This is a convenient stage for testing, since the amount of material purchased will be in sufficient bulk that the material has a readily detectable radiation signature. This ensures the signature can be detected while minimizing radiation exposure to jewelry customers. After manufacturing, the chain of custody for gold jewelry is typically well maintained. For example, jewelry pieces may be inscribed with identifying information.

Alternatively, or additionally, the radioisotopes can be evaluated at the point of retail. For gold and/or platinum that has a radioisotope concentration sufficient for small pieces of jewelry to be tested, the point of retail may be the optimal stage for verification. For example, retailers can test jewelry they hold in their inventory or when it is received from manufacturers before being provided to end customers, as a part of the retailer's quality assurance program.

It should be understood that evaluation of the radioisotopes can be evaluated at multiple points in the supply chain. For example, gold or platinum tested prior to jewelry manufacturing may be re-tested at one or more other points in the supply chain, such as at the point of retail. Further, even if testing is done at earlier stages in the supply chain, it may be preferable to perform evaluation at the site of jewelry manufacturing. Because, for example, gold in the form of cast grains or wire is indistinguishable from other gold supply, there is a great deal of opportunity for fraudulent certificate claims to occur between gold traders and jewelry makers. While testing may confirm that a gold trader purchased certified gold, there's no guarantee (without subsequent additional testing) that the certified gold is the same as what is sold to the jewelry maker.

### Example 3: Metals Used in Electronics

In the case of metals used in electronics (e.g., gold, tin, tantalum), the metals can preferably be tested during the manufacture of the electronic component. A preferred detection point may be at a point of manufacture where the metal is received from a broker or refiner, when it is still aggregated in a large enough form to be tested and a conclusive determination of the source of the material can be made.

Additionally, or alternatively, the radioisotopes can be evaluated in finished electronics. Given these metals are present in small amounts in electronics, customized batches of radioisotopes may be needed that have radioisotope concentrations high enough to ensure detectability in such small amounts. In some applications, the electronic product may need to be disassembled so that the components can be tested without the presence of any shielding.

### Example 4: Steel Used in Automobiles

The radioactivity levels in automotive steel components can be tested before it is shaped (e.g., by the manufacturer). The manufacture can then apply a serial number to the component to allow the provenance and chain of custody of the component to be confirmed at later stages of the supply chain.

Additionally, or alternatively, the radioisotopes can be evaluated at the site of car manufacture. For example, when steel components are being inserted into automobiles, they can be tested prior to assembly into the vehicle, when the components are still unshielded.

It should be understood that in any of the examples described above, the radioactivity levels of materials can be measured by a participant in the supply chain (e.g., smelter, refiner, manufacturer, etc.) or by an independent third-party auditor. For example, in some applications, an independent third-party auditor can track the flow of materials throughout a supply chain to ensure compliance with various requirements (e.g., the minimization of the use of conflict materials).

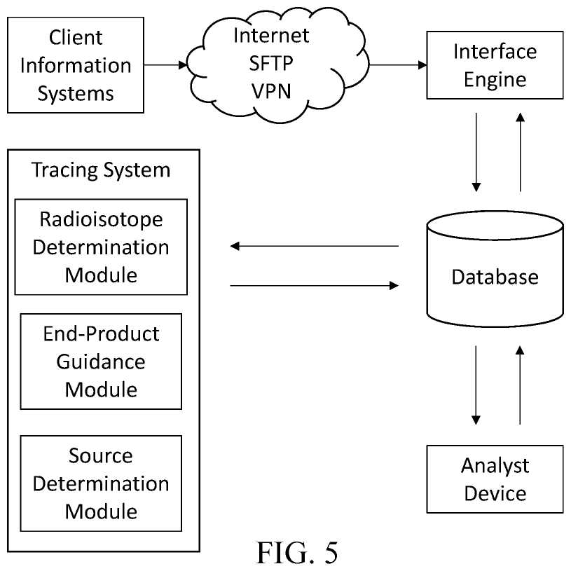

FIG. 5 is a diagram illustrating an exemplary computing environment, consistent with certain disclosed embodiments. As shown in FIG. 5, the environment may include client information systems, an interface engine, an analyst device, and a tracing system, each of which may be interconnected through any appropriate combination of communications networks. Examples of such communication networks include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet. The client information systems can include information systems from a variety of clients, including miners, smelters, refiners, component manufacturers, and manufacturers of end user products. This may allow these entities to access the computing environment to input, and retrieve, information regarding radioisotopes present in a material.

One or more of the aspects of the computing environment may also exchange data across a direct channel of communications. In one aspect, the direct communications channel may correspond to a wireless communications channel established across a short-range communications network, examples of which include, but are not limited to, a wireless LAN, e.g., a “Wi-Fi” network, a network utilizing RF communication protocols, an NFC network, a network utilizing optical communication protocols, e.g., infrared (IR) communications protocols, and any additional or alternate communications network, such as those described above, that facilitate peer-to-peer (P2P) communication.

The client information systems may communicate directly with the interface engine through a secure communication channel, such as a virtual private network (VPN) or any of the communication networks described above. A secure communication channel may be used to prevent unauthorized access to information stored in the databases or databases. This can ensure the accuracy of the source information stored in the database or databases.

In some embodiments, one or more of the aspects of the computing environment may include a computing device having one or more tangible, non-transitory memories that store data and/or software instructions, and one or more processors configured to execute the software instructions. The one or more tangible, non-transitory memories may, in some aspects, store software applications, application modules, and other elements of code executable by the one or more processors, such as a web browser or an application (e.g., a mobile application). For example, the client information systems can include one or more computing devices connected to the computing environment for inputting data into, and extracting data from, the database. For example, the computing devices of the client information systems can be used to determine the source of material based on measured radioactivity levels in a component or sub-batch of material.

The computing environment may also establish and maintain, within the one or more tangible, non-transitory memories, one or more structured or unstructured data repositories or databases, e.g., the database illustrated in FIG. 5. As described above, the database or databases can store information regarding the amount and type of radioisotopes added to a source batch of material. The database or databases can further include information regarding the process steps (including the entity that performed those process steps) that the material has undergone. The database or databases can also include information regarding the maximum component size that a material can be used for such that radioactivity levels are safe to end users. The database or databases can further include information regarding minimum sizes of the material for which radioactivity levels will be detectable. This information can be entered by one or more users. The database can be monitored and maintained by, for example, a certification authority (i.e., an independent third-party auditor) to ensure that the information in the database(s) is accurate.

Referring back to FIG. 5, the analyst device may include a display unit configured to present interface elements to a user, and an input unit configured to receive input from the user, e.g., in response to the interface elements presented through the display unit. By way of example, the display unit may include, but is not limited to, an LCD display unit, LED display unit, OLED display unit, or other appropriate type of display unit, and the input device may include, but is not limited to, a keypad, keyboard, touchscreen, voice activated control technologies, or appropriate type of input device. Further, in additional aspects, the functionalities of the display unit and input unit may be combined into a single device, e.g., a pressure-sensitive touchscreen display unit that presents interface elements and receives input from the user. The analyst device may also include a communications unit, such as a wireless transceiver device, coupled to a processor and configured by the processor to establish and maintain communications with the network using any of the communications protocols described herein.

Examples of the analyst device may include, but are not limited to, a personal computer, a laptop computer, a tablet computer, a notebook computer, a hand-held computer, a personal digital assistant, a portable navigation device, a mobile phone, a smart phone, a tablet, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations, and/or display information on an interface module, consistent with disclosed embodiments. In some instances, the user may operate the analyst device and may do so to cause the analyst device to perform one or more operations consistent with the disclosed embodiments. For example, a user may use the analyst device to input radioactivity levels measured in a component or batch of material in order to query the database to determine the source of the material (e.g., via the source determination module). Alternatively, a sensor, such as a radioactivity detector, may be in communication with the computing environment (e.g., through Wi-Fi or Bluetooth) such that measurement results are communicated directly from the sensor. A user can also use the analyst device to enter information regarding a batch of material, and the amount of one or more radioisotopes introduced to the batch of material. The user of the analyst device can be, for example, an employee or agent of an entity in the supply chain—such as a mine, a refiner, smelter, or a manufacturer. Alternatively, the user of the analyst device can be an employee or agent of an independent third-party auditor. This may allow such a third-party auditor to track the flow of material in a supply chain and ensure that materials are provided by approved sources. In some embodiments, the analyst device is a part of a client information system.

The tracing system includes a radioisotope determination module, an end-product guidance module, and a source determination module. These modules perform the functions described above and communicate with the other aspects of the environment via the communications channels. For example, the radioisotope determination module can be configured to identify one or more radioisotopes to be added to a batch of material. The radioisotope determination module can determine the appropriate radioisotopes to include based on the factors described herein. For example, the determination can be made based on the type of base material. For example, the radioisotope determination module can select radioisotopes such that the radioisotopes and the base material have the same proton number. The radioisotope determination module can further select the type and quantity of radioisotopes to be introduced to the base material such that the base material can be distinguished from other batches of material with records in the database. In some embodiments, the parameters for the radioisotope determination module are set by a third-party auditor or certification body. The end-product guidance module can be configured to calculate the maximum mass or volume of an end product such that radioactivity levels are safe for end users. The end-product guidance module can further be configured to calculate the minimum mass of a material such that radioactivity levels are detectable. The source determination module can be configured to access the database to identify a source of material based on measured radioactivity levels. As described above, this determination may be made based on the decay of the radioactive elements included in the material. Upon determination of the source material, the records in the database(s) associated with that source material can be updated to allow tracking of the processing steps that the material undergoes.

Each module may represent a computing system that includes one or more servers (not depicted in FIG. 5) and tangible, non-transitory memory devices storing executable code and application modules. Further, the servers may each include one or more processor-based computing devices, which may be configured to execute portions of the stored code or application modules to perform operations consistent with the disclosed embodiments. In other instances, and consistent with the disclosed embodiments, one or more of the modules may correspond to a distributed system that includes computing components distributed across one or more networks, such as those provided or maintained by cloud-service providers (e.g., Microsoft Azure).

It will be understood that the foregoing description is of exemplary embodiments of this invention, and that the invention is not limited to the specific forms shown. Modifications may be made in the design and arrangement of the elements without departing from the scope of the invention.

What is claimed is:

1. A method, comprising:
providing a batch of material;
introducing a first radioisotope to the batch of material; and
introducing a second radioisotope to the batch of material;
wherein at least one of the first radioisotope and the second radioisotope has a half-life of at least forty days.

2. The method as recited in claim 1, wherein both the first radioisotope and the second radioisotope emit gamma radiation and/or beta radiation.

3. The method as recited in claim 1, wherein the first radioisotope and the second radioisotope are not neutron emitters such that decay of the radioisotopes does not make the batch of material radioactive.

4. The method as recited in claim 1, wherein the batch of material and the radioisotopes have the same proton number.

5. The method as recited in claim 1, wherein the radioisotopes are a material that is commonly used as an alloying agent for the batch of material.

6. The method as recited in claim 1, comprising introducing a first radioisotope to the batch of material, wherein the first radioisotope has a first half-life; and
introducing a second radioisotope to the batch of material, wherein the second radioisotope has a second half-life;
wherein the first half-life is at least forty days longer than the second half-life.

7. The method as recited in claim 1, comprising introducing a first radioisotope to the batch of material, wherein the first radioisotope has a first radiation peak; and
introducing a second radioisotope to the batch of material, wherein the second radioisotope has a second radiation peak;
wherein the first peak is at least 100 keV apart from the second peak.

8. A computer-implemented method, comprising:
identifying a radioisotope to be introduced to a batch of material;
determining an amount of the radioisotope to be added to the batch of material; and
calculating a maximum mass of material that can be included in an end product without exposing users to dangerous levels of radioactivity.

9. The method as recited in claim 6, further comprising calculating a minimum mass of material such that radioactivity can be detected at a specified time after introduction of the radioisotope into the material.

10. A computer-implemented method, comprising:
receiving a first set of information, the first set of information including an amount of a first radioisotope in a component;
receiving a second set of information, the second set of information including an amount of a second radioisotope in the component; and
identifying, based on the first set of information and the second set of information, a source batch of material, wherein the component is produced from the source batch of material.

11. The method as recited in claim 10, further comprising receiving a third set of information, the third set of information including the elapsed time since introduction of the first radioisotope and the second radioisotope into a material, and wherein the identifying step is further based on the third set of information.

12. The method as recited in claim 10, wherein a tracer is used to trace the source of materials in products of any size, as the radioisotope ratio of radioactivity is invariant to the size of the component.

13. The method as recited in claim 10, wherein the radioisotope ratio of radioactivity does not change when traced material is mixed with non-traced material.

14. The method as recited in claim 12, wherein ratings for the maximum size of the component containing the tracer are assigned, based on the safe amount of radioisotopes which can be present and safely expose people.

15. The method as recited in claim 12, wherein ratings for the minimum size of the component containing the tracer are assigned, based on the minimum amount of radiation which can be detected using available detection equipment.

16. The method as recited in claim 13, wherein the concentration of the first radioisotope or second radioisotope is measured, and then used with the radioisotope ratio of radioactivity to determine the amount of dilution of traced material.
